(19) United States
(12) Patent Application Publication
(10) Pub. No.: US 2025/0356069 A1
(43) Pub. Date: Nov. 20, 2025

(54) System of Preconfigured Structural Components and Method for Assembly of the Same Adaptable for Environments Susceptible to Climate Change

(71) Applicant: X-Frame Pty Ltd, Parkside (AU)

(72) Inventors: Luke Ransfield, Parkside (AU); Harrison Le Fevre, Parkside (AU); Gerard Finch, Wellington (NZ)

(21) Appl. No.: 18/871,990

(22) PCT Filed: Jun. 9, 2023
(86) PCT No.: PCT/AU2023/050510

§ 371 Date: Dec. 5, 2024

(30) Foreign Application Priority Data
Jun. 10, 2022 (AU) 2022901589

(51) Int. Cl. G06F 30/13

(52) U.S. Cl. CPC G06F 30/13

(57) ABSTRACT

A system and method for architecturally designing and manufacturing building structures customized for environments vulnerable to extreme weather events or other natural phenomena. The method includes determining an environmental susceptibility of a proposed building location, designing building components factoring in geographical and climate-related features, manufacturing the building components, and assembling the building structure in a manner better configured to resist extreme weather or natural events.

### FIELD OF THE INVENTION

The present disclosure relates to improvements in manufacturing processes used to manufacture pre-configured fixed size components used for constructing prefabricated building systems, particularly in environments susceptible to climate change considerations.

### BACKGROUND OF THE INVENTION

Conventional prefabricated building system manufacturing processes create and produce all unique parts to match a specific design. This results in material wastage, higher cost and limited ability to reuse/recycle materials. Many conventional prefabricated building systems are a one-size-fits-all system that does not take into account environmental considerations that will have an impact on structural integrity, such as location in a floodplain or earthquake zone. Such considerations are becoming more important in view of continued major weather events and other natural events.

The present disclosure seeks to lessen these problems by providing a manufacturing system and method for prefabricated building systems which allows the company to apply and re-apply optimally produced, preconfigured fixed size components to bespoke architectural elements of a building, as well as provide structures better-designed for environments more vulnerable to extreme natural events.

It will be clearly understood that, if a prior art publication is referred to herein, this reference does not constitute an admission that the publication forms part of the common general knowledge in the art.

### SUMMARY

The present disclosure in one preferred aspect provides for a system of preconfigured structural components that are customized for assembly in environments susceptible to extreme natural events. The system includes a plurality of connection brackets of differing sizes with a plurality of apertures configured for horizontal, vertical and angular connection; a plurality of connection beams of differing lengths with a plurality of projections at each end for interdigitation with the apertures of the connection brackets to permit attachment and detachment of the beams from the brackets, the plurality of beams connecting with the connection brackets to form a frame; a plurality of lining tiles with a plurality of lining tile apertures configured to interdigitate with the frame to form a building sheet, the lining tile apertures being positioned to interdigitate with predetermined utility service outlets; and a processor. The processor is configured to: determine an environmental susceptibility of a location of a structure to be assembled; generate a design grid of a proposed structure; and output a design of one or more structural components based on the determined environmental susceptibility and preconfigured utility connections.

In another aspect, the present disclosure sets forth a method of manufacturing building components based on location susceptibility to extreme natural events. The method includes: determining an environmental susceptibility of a location of a structure to be assembled; generating a design grid of the structure; ascertaining locations of connections on building components for assembling the components to each other, based at least in part on the environmental susceptibility determination; ascertaining locations of utility connection apertures on a plurality of building tiles for placement with utility connections based at least in part on the environmental susceptibility determination; and manufacturing the building components according to the ascertained connection and utility connection locations.

Another preferred aspect of the disclosure sets forth to apply a plurality of connection brackets of variable sizes and with a plurality of apertures to be configured for horizontal, vertical and angular placement of components.

A further aspect of the disclosure utilises a plurality of connection beams of variable lengths with a plurality of projections at the end for interdigitation with apertures of the connection bracket to permit attachment and detachment of the beams from the brackets, the plurality of beams connecting with the plurality of connection brackets to form a frame.

According to another aspect of the disclosure there is provided for a plurality of lining tiles with a plurality of apertures configured to interdigitate the frame to form a building panel.

Another aspect of the disclosure is that there are provided for a plurality of apertures on the lining tiles configured to interdigitate with services such as electricity, gas and water outlets.

In a further aspect, the system incorporates a comprehensive suite of artificial intelligence (AI) processes to improve module design and part optimization. By harnessing data generated throughout the design process, the system employs advanced pattern recognition methodologies. This allows the system to prepare cut sheet part selection and layout efficiently, with the primary objective of maximizing material utilization across all projects. Moreover, the system employs an unsupervised machine learning model to enhance custom panel generation while adhering to the constraints of a modular configuration. Leveraging existing custom panel data, this AI-driven approach enables the rapid and efficient production of custom building components, ensuring optimal material utilization is achieved. To further enhance design efficiency, the system employs an AI system that manipulates design input geometry, such as floorplans. Leveraging a combination of supervised and reinforcement machine learning techniques, this AI component is configured to attain maximum utilization of design building modules while preserving the original design intent.

It is to be understood that both the foregoing general description and the following detailed description are exemplary and explanatory only and are not restrictive of the invention, as claimed. In the present specification and claims, the word “comprising” and its derivatives including “comprises” and “comprise” include each of the stated integers but does not exclude the inclusion of one or more further integers.

It will be appreciated that reference herein to “preferred” or “preferably” is intended as exemplary only. The claims as filed and attached with this specification are hereby incorporated by reference into the text of the present description. The accompanying drawings, which are incorporated in and constitute a part of this specification, illustrate several embodiments of the invention and together with the description, serve to explain the principles of one or more forms of the invention.

### BRIEF DESCRIPTION OF THE FIGURES

In order to explain the disclosure, a number of embodiments of the disclosure will be described below with reference to the drawings, in which:

FIG. 1 is a diagram of the system in accordance with a preferred embodiment of the present disclosure.

FIG. 1A describes external project inputs (EI) of the system referring to FIG. 1.

FIG. 1B describes system project variables (SR) of the system with reference to FIG. 1.

FIGS. 2A to 2Q describe design database inputs (DI) of the system with reference to FIG. 1.

FIG. 2A depicts a method for defining and describing of a curve.

FIG. 2B is a view of a curve division method in accordance with another preferred embodiment of the present disclosure.

FIG. 2C depicts a method for how the wall finished height is obtained by using a wall module height.

FIG. 2D shows a method of fixed size building panel determination alongside custom size building panels as well as conducting building panel counting.

FIG. 2E illustrates a method for the generation of building panel identification and attributes.

FIG. 2F depicts a method for calculating a corner building panel condition.

FIG. 2G provides a perspective view of building panel face orientation method which adds to a further layer of building panel attribute information.

FIG. 2H describes a method for building panel face division into stud lines.

FIG. 2I depicts a method for building panel stud line node division.

FIG. 2J provides a perspective view of the method for determining node division orientation.

FIG. 2K illustrates a method of grouping building panel orientation planes for downstream component placement.

FIG. 2L shows a method for orientating building planes after orientation of blocks.

FIG. 2M is a view of the block placement method.

FIG. 2N shows the process method output with reference to FIG. 1.

FIG. 2O illustrates a lining material tile fixing and interdigitation method in accordance with another preferred embodiment of the present disclosure.

FIG. 2P describes a method for identification of apertures for services and interdigitation thereof onto wall lining tiles as another preferred embodiment of the present disclosure.

FIG. 2Q displays a complete model depicting a building panel populated with brackets and beams in reference to an overall building project.

FIG. 3 shows more detail around the curve division step of FIG. 2B.

FIG. 4A is another view of the preconfigured fixed size block placement method with reference to FIG. 2M.

FIG. 4B is another view of the custom size block creation and placement method with reference to FIG. 2M.

FIG. 5A shows a flow diagram of a nesting method to prepare manufacturing instruction (cut) files.

FIG. 5B shows a flow diagram of the drawing compilation and assembly instruction generation method when transferring a custom size building panel to a sheet.

FIG. 5C provides a flow diagram and detail of a method for compiling project data and customer quotes.

FIG. 6 is a flow diagram of a web integration of the system of FIG. 1.

### DETAILED DESCRIPTION OF THE DRAWINGS

A purpose of the system is to interpret and examine a building's spatial qualities and accompanying geometry obtained from the building's digitised design which can be taken or loaded in from various design platforms. The system does the interpretation and examination by preferably first overlaying a predefined system grid, defined by system and design rules, onto the digitised building plan also considering the building project variables and then matching this to the system's structural modules.

The system applies and analyses the effectiveness of this predefined system grid from various locations in the building's plan and for each wall section to calculate and produce strategic option decisions in respect to optimising the building's geometry and formulating options with varying levels of geometric standardisation, preferably taking into account the geographic location and environmental susceptibility factors of a particular region.

After completing the grid and module standardisation and optimisation analysis, the system methodically imposes structural modules onto the building's spatial qualities and geometry to arrive at an optimised geometry in full detail. The system automatically identifies corner conditions, panel types and openings and populates each building panel with preconfigured components. Preconfigured components are split into preconfigured fixed size components that are loaded in from a system master template defined by predefined design and system rules and custom size components that are generated to suit unique project requirements based on the structural and geometrical system rules of the preconfigured fixed size components with the aim of maintaining as many standardised components as possible.

Fabrication and assembly data are produced once all building panels have been populated with components. Custom building panels are automatically identified and accompanying exploded view isometric drawings of each custom panel utilised, are generated and custom identifiers assigned. These drawings are collated and made available to third party manufacturers or builders (depending on the project delivery requirements). Key plan and accompanying construction guidance are also embedded as part of the assembly data. Drawings for fixed size building panels are available from the system design database and automatically generated by the system. Digital manufacturing files and project data are also produced from the system design database.

Another feature of the system is to apply lining material tiles to each geometric plane of the optimised building design (i.e., wall, floor and roof surfaces). The system interprets and examines the bounding geometry of each geometric plane and overlays onto it the predefined fixing grid defined by system and design rules. Lining material tile fixing points are then imposed automatically. The workflow allows the user to quickly change the configuration of these linings (modifying the shadow gap, skirting, scotia, and penalisation). As changes are made, the system updates the lining material tile cut sheets and produces fabrication and assembly data.

Another feature of the system is projecting the position of utility services (i.e., power, water, communication) on the geometric plane lining material tiles as presented by the optimised building design. Apertures are then provided for the position of utility services.

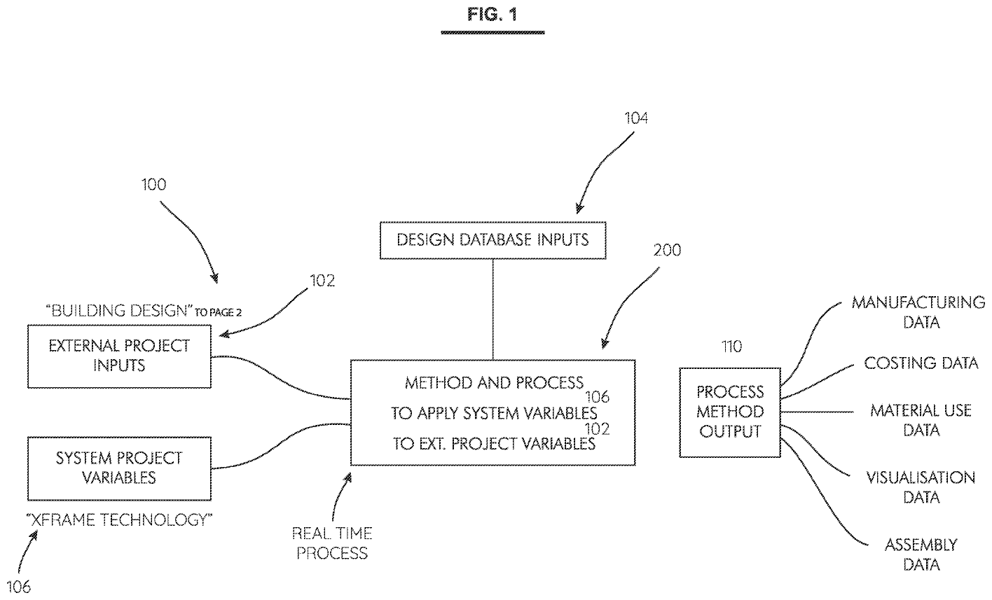

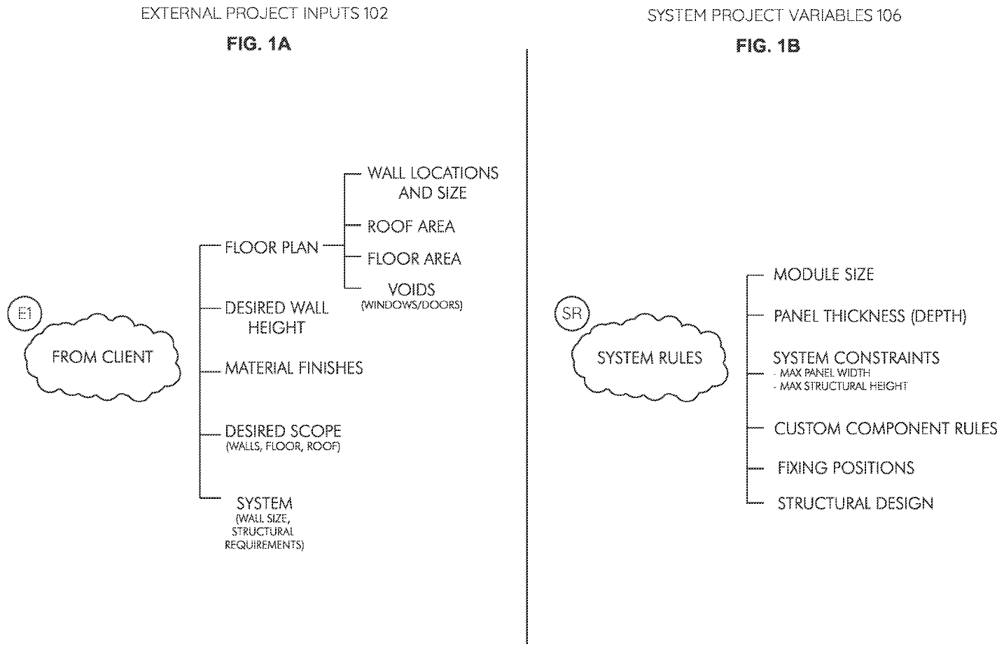

Referring now to FIG. 1, a system 100 for initially examining a building's geometry (External Project Inputs (EI)) 102 against a predetermined grid by matching this to the structural modules of the system. Process method 200 applies System Project Variables (SR) 106 and Design Database Inputs (DI) 104 to analyse the effectiveness of this predetermined grid from various locations in the building's plan and for each geometric plane. This permits maximum level of preconfigured fixed size component utilisation without compromising the bespoke design qualities of the building.

Continuing with reference to FIG. 1, process method 200 optimises a building's geometry (External Project Inputs (EI)) 102 by further applying System Project Variables (SR) 106 to create process method output 110 and produce strategic option decisions in respect to optimising the building's geometry (External Project Inputs (EI)) 102, formulating options with varying levels of geometric optimising, for example three (3) options with varying level of likeness to the original ingested building design. For each of the process method output 110 options, a report is generated as to how many preconfigured fixed size building panels 112 vs custom size building panels 114 are being utilised by each building option. This is done for all geometric planes and all building lining components.

Option 1 maintains the building's original design without changes. Option 2 includes minor changes. Option 3 aims for full-scale preconfigured fixed size component utilization which will ensure constructional simplicity, best material yields, improved structural performance and reduced project costs. A perceived benefit of Option 3 is that the client can achieve a larger building structure at a lower or similar cost compared to the Option 1 design.

With continued reference to FIG. 1, system 100 systematically applies the preconfigured fixed sized building panels 112 to the geometry selected for the building by means of process method 200. Custom size building panels 114 are thereafter used to complete the population of the selected geometry.

FIG. 1 further shows system 100 where fabrication, assembly, costing, material yield and visualisation information are generated as part of process method output 110 after preconfigured fixed sized building panels 112 have been populated with preconfigured fixed size components and custom size building panels 114 have been populated with custom size components.

External Project Inputs (EI) 102 are described in FIG. 1A. These are obtained from the client either in the form of architectural plans or external data sources where the obtaining of the mapping includes digitalising the plans into a digital format to create a data source. Information obtained from this include: the floor plan (includes wall locations, wall size, roof area, floor area, openings (windows and doors)), desired wall height, material finishes, desired scope (walls, floor, roof) and system requirements (wall size structural requirements).

FIG. 1B describes selected System Project Variables (SR) 106 such as module size, panel thickness (depth), preconfigured fixed size components, fixing positions, structural design, system constraints such as the maximum panel width and maximum structural height and custom component rules.

Design Database Inputs (DI) 104 of the system includes items such as a material database, corner overrides and building panel overrides for doors, windows and voids, shown in FIG. 1C.

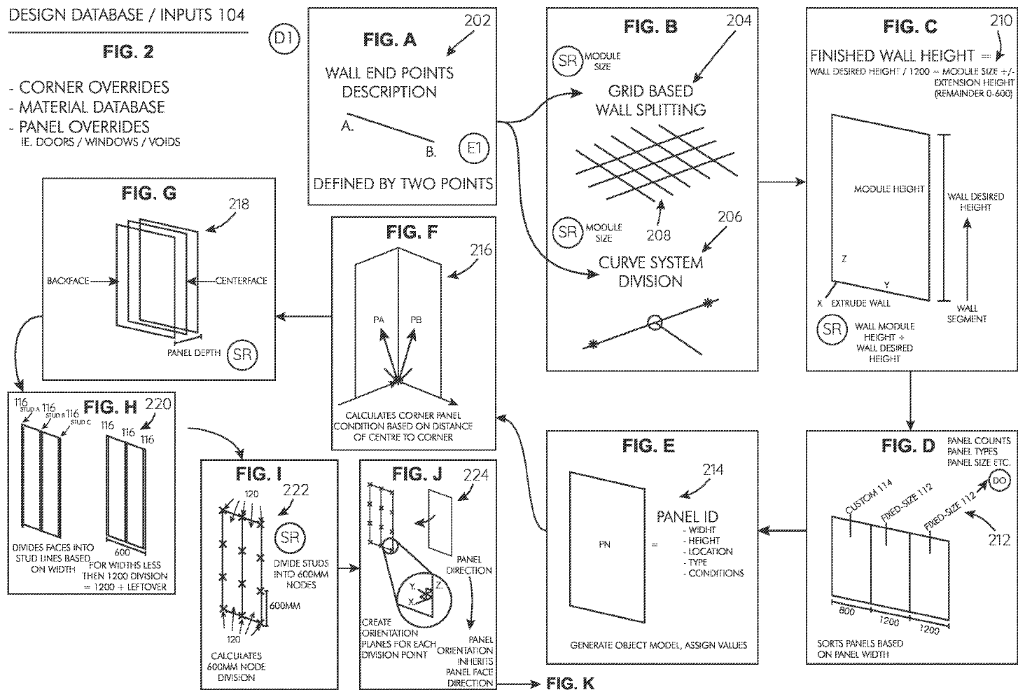

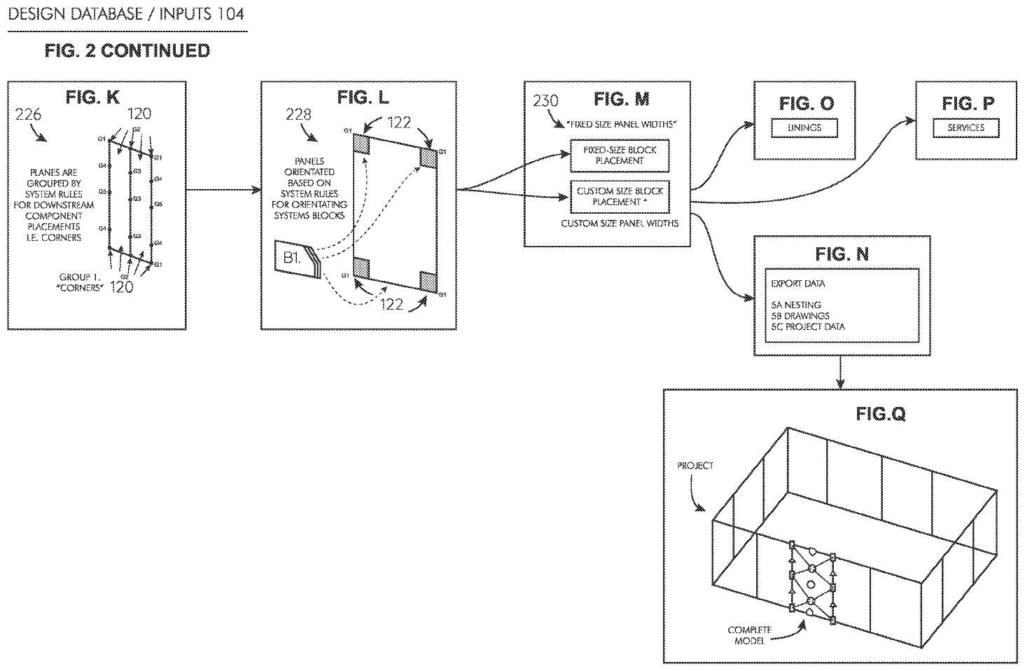

Method 202 as depicted in FIGS. 2A to 2Q is a preferred method for defining and describing of a curve which is the linking of a start point and an end point and represents the ‘base and centre’ of the building's geometry (External Project Inputs (EI)) 102 and sets exemplary limits or boundaries within which the system module will function.

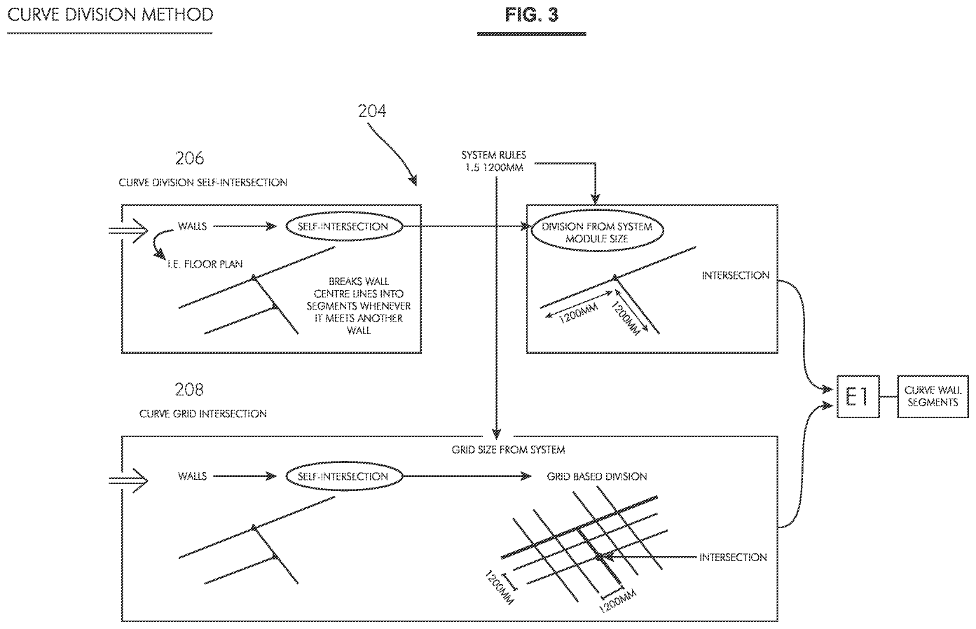

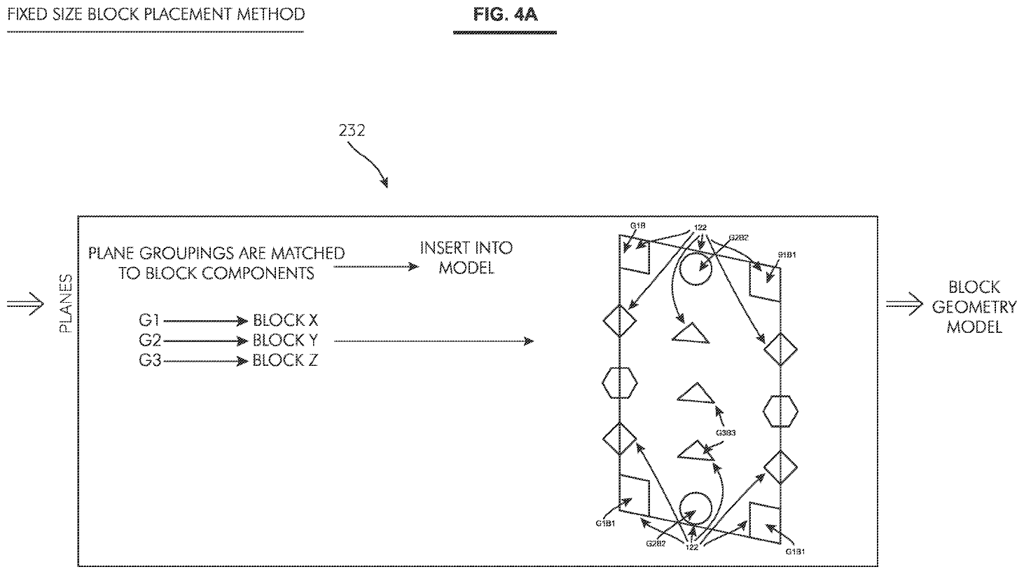

FIG. 2B is a view of a curve division method 204 in accordance with another preferred embodiment of the present disclosure. FIG. 2B illustrates that the curve division method 204 takes place by either self-intersection method 206 as shown in FIG. 3 or grid intersection method 208 (also shown in FIG. 3).

FIG. 3 provides for more detail on the curve division method 204 as mentioned in FIG. 2B, with the two preferred methods being curve division self-intersection 206 and curve division grid intersection 208. Referring to FIGS. 1 and 3, with the curve division self-intersection method 206, it divides the wall centre line into segments whenever it meets another wall. Hereafter the system applies System Project Variables (SR) 106 to divide the building geometry (External Project Inputs (EI)) 102 based on system module size, resulting in curves. With the curve division grid intersection method 208, it again divides the wall centre line into segments whenever it meets another wall, but it carries on performing a grid-based division on the building geometry (External Project Inputs (EI)) 102 based on a grid size when applying system project variables (SR) 106, resulting in curve wall segments.

FIG. 2C illustrates preferred method 210 for representing the finished wall height by using the wall module height of 1200 mm as specified in the system project variables (SR) 106 and then adding to or subtracting from that an extension height. The wall module height may be in 600 mm multiples if desired.

FIG. 2D shows a preferred method 212 of fixed size building panel 112 determination alongside custom size building panels 114 and also conducting panel counting whereby panels are counted based on the panel width which was determined through the preferred curve division methods as described relative to FIGS. 2B and 3. Building panels which conform to maximum module width of 1200 mm as set out by System Project Variables (SR) 106 are defined as fixed size building panels 112 and building panels smaller than the maximum module width is defined as custom size building panels 114.

FIG. 2E illustrates method 214 which is preferred for the generation of building panel identification and attributes. At this step a building panel's unique attributes are assigned to its identification attributes. Attributes includes width, height, location within the building geometry (External Project Inputs (EI)) 102, type and condition.

Referring now to FIG. 2F, a preferred method 216 for calculating the corner building panel condition whereby its condition is based on the distance of its centre to its corner is described. This is a noteworthy step since a corner building panel would not fit into any other position within the building geometry (External Project Inputs (EI)) 102 since the distance of its centre to corner is relevant for the corner position to which it is assigned. Corners are preferably generated at non-planar intersections. A corner type is preferably generated automatically by assigning a male and female corner condition using the curve length. If the length is the same an overlap condition is added automatically to the first line in the sequence. A corner override for a changing corner condition is preferably based on selecting the edge of the wall plane.

FIG. 2G provides a perspective view of a building panel face orientation method 218 which adds to a further layer of building panel attribute information. Assigning orientation through applying system project variables (SR) 106 to a building panel is a noteworthy step to prevent mirroring (flipping it 180 degrees) which could lead to incorrect node 120 division as per a method that will be described in FIG. 10 further below. A front face, centre face, back face and building panel depth is assigned during the building panel face orientation.

FIG. 2H describes a preferred method 220 for building panel face division into stud 116 lines where each building panel will have predetermined stud 116 positions as per the system project variables (SR) 106 based on the width of the building panel. For Custom Size Building panels 114 with a width of less than 1200 mm, the division is preferably performed based on a 600 mm division plus any remainder.

Preferred method 222 is shown in FIG. 2I where studs 116 are divided by nodes 120 into preferably lengths of 600 mm. Preferably, the studs overlap to provide more strength from short members where short members are used or envisioned.

FIG. 2J provides a perspective view of a preferred method 224 where node 120 orientation as a product of building panel orientation are determined with each node 120 gets assigned an orientation or plane based on its position within the building panel. This is once again a noteworthy step to prevent mirroring (flipping it 180 degrees) of node 120. Whenever node 120 is mirrored, it may cause the building panel to not fit into the building geometry (External Project Inputs (EI) 102) anymore.

A planes grouping method 226 is illustrated in FIG. 2K by applying system project variables (SR) 106 for downstream component placement.

FIG. 2L shows a preferred method 228 where planes are orientated by applying system project variables (SR) 106 after orientation of system blocks or brackets 122. Based on the graph (a series of curves-edges and nodes) intersections conditions are used to inform block placement and orientation.

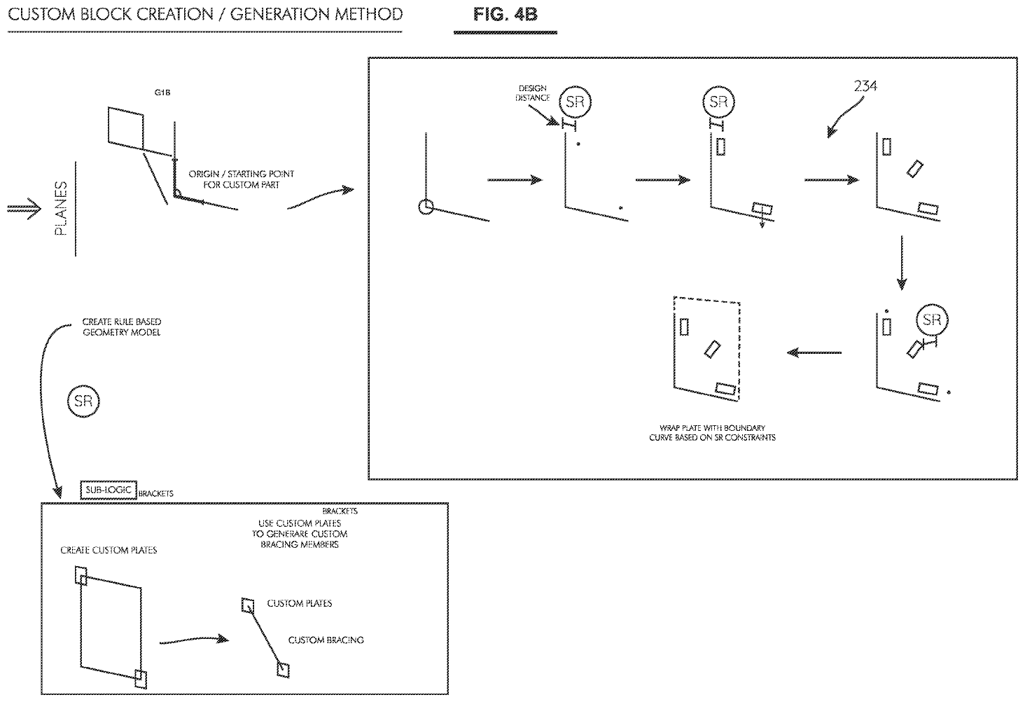

FIG. 2M is a view of a block placement method 230 to place block or connection bracket 122 within a building panel. FIG. 2M displays that the block or connection bracket 122 placement method within a building panel takes place by employing either one of two preferred methods being either fixed size block placement method 232 resulting in fixed size building panels as displayed in FIG. 4A or custom size block placement method 234 resulting in custom size building panels, displayed in FIG. 4B.

FIG. 4A depicts the preconfigured fixed size block or connection bracket placement method 232 shown in FIG. 2M to produce fixed size building panels 112 where plane groupings are matched to block or bracket 122 components and inserted to produce a fixed size building panel 112. Fixed size connection beams or braces 124 are used to connect with fixed sized blocks or backets 122.

FIG. 4B depicts the custom size connection bracket placement method 234 shown in FIG. 2M to produce custom size building panels 114. Preferred method 234 starts by creating a rule-based geometry model using one corner as the origin or anchor point for placing a custom size block or bracket 122 and from there placing all other custom size blocks or brackets 122 using the origin or anchor point as reference. This placement is based on system project variables (SR) 106. Custom size connection braces or beams 124 are generated to connect with custom sized brackets 122.

FIG. 2N describes process method output 110 shown in FIG. 1. Data being generated includes, but is not limited to manufacturing data, construction and assembly drawings and instructions, visualisation models, project specific data and costing models.

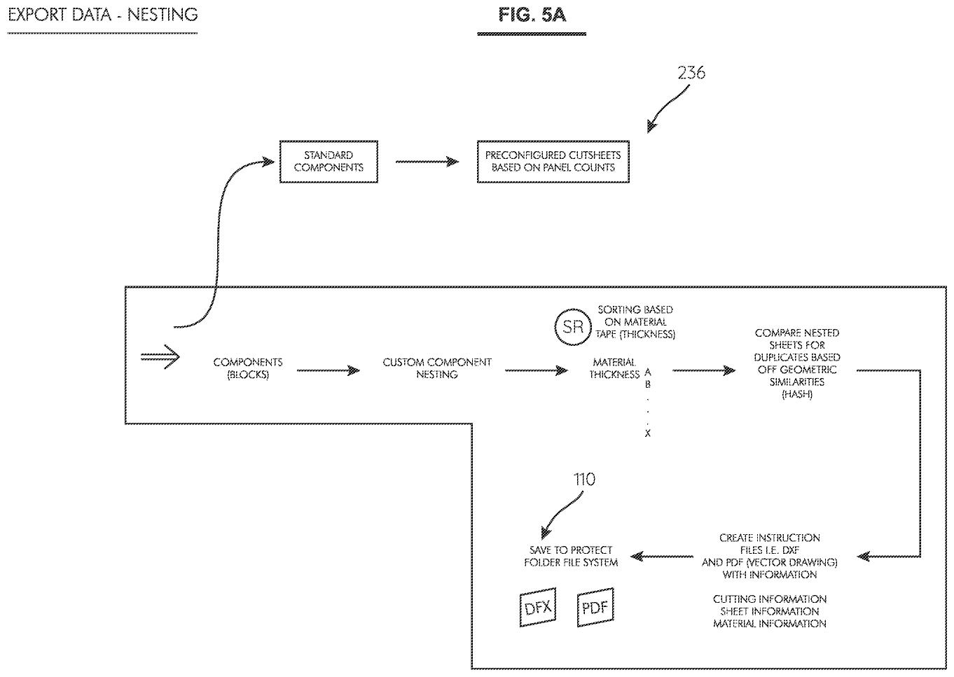

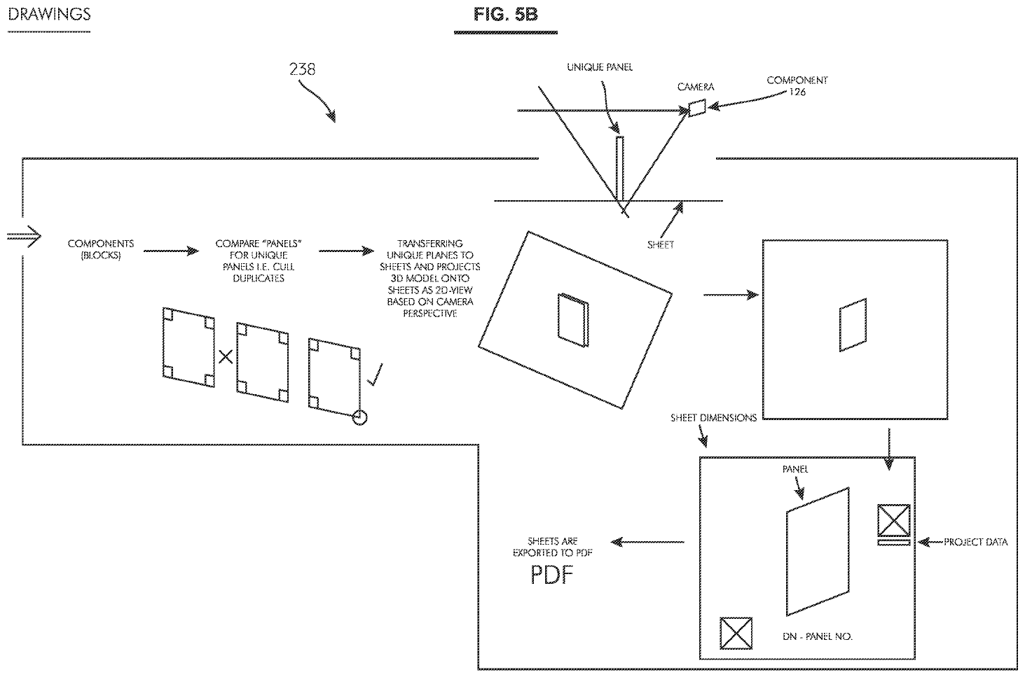

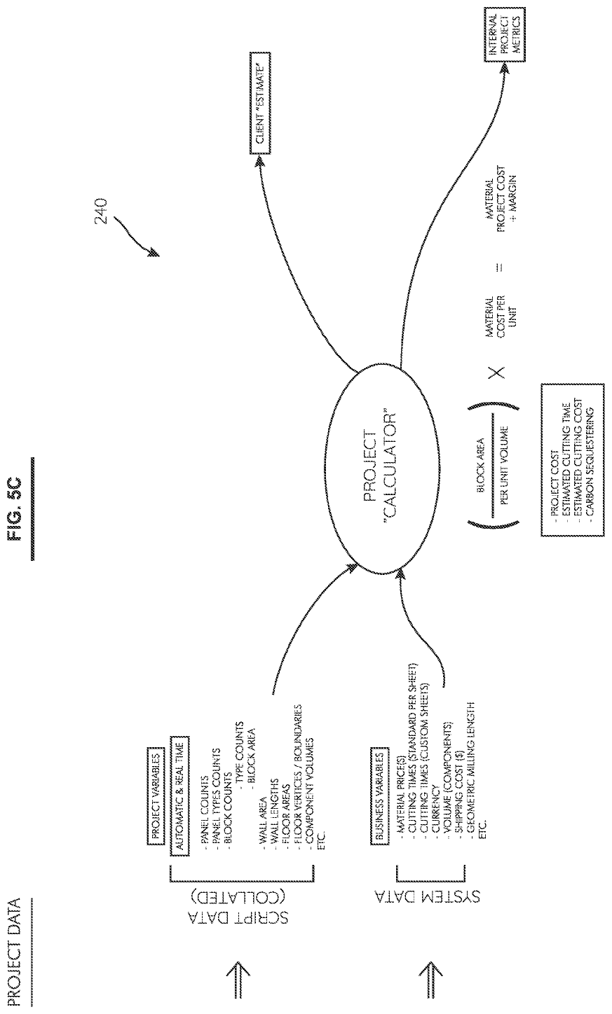

FIG. 5A shows a flow diagram of a preconfigured component nesting method 236 to prepare manufacturing instruction (cut) files for any computer numerical control (CNC) machine to execute which is external of system 100. In the case for preconfigured fixed size components, preconfigured cut sheets for connection blocks 122 and connection beams 124 are generated by method 212 based on fixed size building panel 112 counts as described in FIG. 5. For the situation of custom size components, component nesting of custom connection blocks 122 and custom connection beams 124 are continued to be performed by method 236 by firstly sorting based on material type/thickness. Parts are preferably automatically arranged on stock to take best advantage of available material and the raw materials structural properties (outside of 100). Nested sheets are then compared to one another with the purpose to identify duplicates based of geometric similarities, also known as “hashing.” Next, instruction files are created in CNC machine compatible format along with informative vector drawings. These are saved to the project folder file system as part of process method output 110.

FIG. 5B shows a flow diagram of how the drawing compilation and assembly instruction generation method 238 is applied for custom sized building panels 114. Compilation of drawings for fixed size building panels 112 are already provided for in the Design Database Inputs 104, and thus not illustrated in FIG. 15b. For the generation of drawings and assembly instruction for custom size building panels 114 as covered in FIG. 4B, panels are first compared to one another to identify and eliminate duplicate panels. Using camera component 126, custom size building panels 114 as a 3D model from the perspective of camera component 126 are projected onto a sheet as a 2D model. The 2D model along with project data and building panel information and attributes as determined in FIG. 2E are generated onto drawing sheets.

FIG. 5C shows a flow diagram and detail pertaining method 240 for compiling project data and customer quotes. Method 240 uses two input streams, namely project variables and business variables, to compile project data and customer quotes. Project variables are generated automatically and in real-time. Project variables include, but are not limited to building panel counts, building panel type counts, connection bracket counts, connection bracket type counts, connection bracket area, wall areas, wall length, floor areas and floor vertices/boundaries. Business variables include, but are not limited to material pricing, cutting times (preconfigured fixed size components per sheet), cutting times (custom size components per sheet), geometric milling length, currency exchange rates, component volumes and shipping costs, etc. Project data includes, but are not limited to project cost, estimated cutting times, estimated cutting costs and carbon sequestering. It will be appreciated that the steps of various methods described above may be performed in a different order, varied, or some steps omitted entirely without departing from the scope of the present disclosure.

The structure of a connection block or any block is like that of the connecting bracket, so unless otherwise noted, the description of the block will be understood to apply to a connection bracket or just bracket 122 as appropriate.

The structure of a connection brace or any brace is like that of the connection beam, so unless otherwise noted, the description of the brace will be understood to apply to a connection beam or just beam 124 as appropriate.

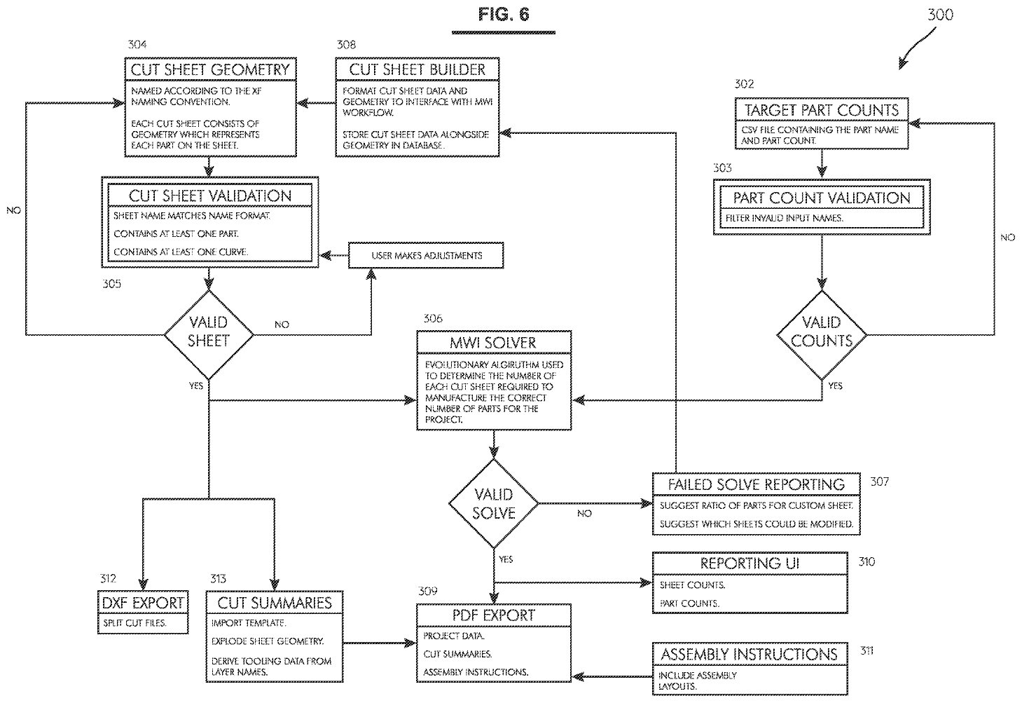

FIG. 6 shows a process 300 that packages manufacturing information for exchange with a distributed manufacturing partner from the block-based model workflow. The manufacturing work instruction utility inputs required part quantities from the production tools and generates relevant documentation to support manufacturing of the specified items. Target part counts 302 following a validation process 303 to resolve incorrect input data are fed from the production toolset into the iterative evolutionary solver 306. The solver 306 works to identify the quantity of standardized/indexed/pre-optimized ‘sheets’ to be manufactured. The solver can draw on stocked parts (data pulled locally or from the web) to reduce the qty of sheets required to be fabricated. The tolerance of acceptable spares can be adjusted (‘Valid Solve’).

An Invalid solve state occurs when actual part counts fail to meet target part counts. In an invalid solve state 307 new automatically generated sheet configurations containing combinations of the blocks required to meet the target part counts are fed back into the cut sheet builder 308 for which the cut sheet geometry is generated 304 and validated 305 to ensure custom cut sheets are both efficient in material utilisation and suitable for manufacturing. The solver 306 is rerun with the addition of the new custom sheets in an iterative loop until an acceptable solution is reached.

Once an acceptable solve is reached the data is pushed to an export process which creates a PDF document 309 containing project and manufacturing information. Included in this document are cut summaries 313 defining the tooling attributes and quantity of each sheet to be manufactured along with assembly instructions 311 indicating the process for assembling each panel. Also included in this export are DXF files 312 containing the cutting toolpaths for each of the required cut sheets.

The foregoing description is by way of example only, and may be varied considerably without departing from the scope of the disclosure. For example only, the system may include a processor configured to determine an environmental susceptibility of a location of a structure to be assembled; generate a design grid of a proposed structure; and output a design of one or more structural components based on the determined environmental susceptibility and preconfigured utility connections. The processor may be configured to utilize elements of artificial intelligence to determine a location's environmental susceptibility in a design of a building. The elements may include generation of at least one feature set with features including historical weather events for a proposed building site, assembling at least one feature vector from the feature set, and feeding the at least one feature vector into an artificial neural network to generate a determination of the proposed building site's environmental susceptibility to environmental phenomena. Aspects of artificial intelligence would be appreciated by those in the AI field, and for simplicity, are not repeated herein. Examples of environmental and geographical factors forming part of any analysis for design include, but are not limited to, location in a flood-prone area (coastal or floodplain), historical climate considerations (drought and rain cycles), prevalence of wildfire activity, volcanic activity, and earthquake activity (including historical). Artificial intelligence may be used to effectively determine predictions of environmental impacts of weather-related events, or other natural phenomena, and provide design outcomes to minimize such impacts. For example, stronger, durable building frames in earthquake zones, which would not naturally be part of any prefabricated building structures; or elevated areas within structures to help mitigate any flood damage where an AI determination indicates a higher likelihood of a flood event.

The features described with respect to one embodiment may be applied to other embodiments or combined with or interchanged with the features of other embodiments, as appropriate, without departing from the scope of the present disclosure.

Other embodiments of the disclosure will be apparent to those skilled in the art from consideration of the specification and practice of forms of the embodiments disclosed herein. It is intended that the specification and examples be considered as exemplary only, with a true scope and spirit of the disclosure being indicated by the following claims.

What is claimed is:

1. A system of preconfigured structural components that are customized for assembly in environments susceptible to extreme natural events, comprising:
a plurality of connection brackets of differing sizes with a plurality of apertures configured for horizontal, vertical and angular connection;
a plurality of connection beams of differing lengths with a plurality of projections at each end for interdigitation with said apertures of said connection brackets to permit attachment and detachment of said beams from said brackets, said plurality of beams connecting with said connection brackets to form a frame;
a plurality of lining tiles with a plurality of lining tile apertures configured to interdigitate with said frame to form a building sheet, said lining tile apertures being positioned to interdigitate with predetermined utility service outlets; and
a processor configured to:
determine an environmental susceptibility of a location of a structure to be assembled;
generate a design grid of a proposed structure; and
output a design of one or more structural components based on the determined environmental susceptibility and preconfigured utility connections.

2. The system of claim 1, wherein said processor is configured to utilize elements of artificial intelligence to determine a location's environmental susceptibility in a design of a building, said elements including generation of at least one feature set with features including historical weather events for a proposed building site, assembling at least one feature vector from said feature set, and feeding the at least one feature vector into an artificial neural network to generate a determination of the proposed building site's environmental susceptibility to environmental phenomena.

3. The system of claim 1, where the utility services outlets include electricity, gas and water outlets.

4. A method of manufacturing building components based on location susceptibility to extreme natural events, the method comprising:
determine an environmental susceptibility of a location of a structure to be assembled;
generating a design grid of the structure;
ascertaining locations of connections on building components for assembling the components to each other, based at least in part on the environmental susceptibility determination;
ascertaining locations of utility connection apertures on a plurality of building tiles for placement with utility connections based at least in part on the environmental susceptibility determination; and
manufacturing the building components according to the ascertained connection and utility connection locations.

5. The method of claim 4, further comprising defining wall end points of a building's geometry.

6. The method of claim 4, further comprising dividing determined curves of a building's geometry.

7. The method of claim 6, wherein the step of dividing occurs through curve division self-intersection.

8. The method of claim 6, wherein the step of dividing occurs through curve division grid intersection.

9. The method of claim 4, further comprising determining building panel face orientation of a building panel within a building's geometry.

10. The method of claim 9, further comprising dividing the orientated building panel face into stud lines.

11. The method of claim 10, further comprising performing building panel stud line node division.

12. The method of claim 11, further comprising determining building panel node division orientation.

13. The method of claim 4, further comprising orientating building panel planes based on building panel node orientation for downstream building panel component placement.

14. The method of claim 4, further comprising capturing a 3D digital image of a custom size connection block or bracket and projecting it onto a two-dimensional drawing plane.
